(19) United States
(12) Patent Application Publication
(10) Pub. No.: US 2013/0246175 A1
(43) Pub. Date: Sep. 19, 2013

(54) SELECTIVELY PRESENTING ADVERTISEMENTS TO A CUSTOMER OF A SERVICE BASED ON A PLACE MOVEMENT PATTERN PROFILE

(71) Applicants: Eric P. Bilange, San Diego, CA (US); Ian R. Heidt, Carlsbad, CA (US)

(72) Inventors: Eric P. Bilange, San Diego, CA (US); Ian R. Heidt, Carlsbad, CA (US)

(73) Assignee: QUALCOMM LABS, INC., San Diego, CA (US)

(21) Appl. No.: 13/613,849

(22) Filed: Sep. 13, 2012

Related U.S. Application Data
(60) Provisional application No. 61/566,897, filed on Dec. 5, 2011.

(51) Int. Cl. G06Q 30/02

(52) U.S. Cl. CPC G06Q 30/0261
USPC 705/14.53

(57) ABSTRACT

In an embodiment, a first communications device monitors movement of a customer that subscribes to a service of a vendor, determines, based on the monitoring, a list of places that are habitually visited by the customer within a threshold period of time of each other, and generates a place movement pattern profile (PMPP). In another embodiment, a second communications device determines advertisement campaign rules for presentation of advertisements for the service based on the PMPP, detects that the customer is engaged in a visit to the list of places in a manner consistent with the PMPP, and delivers advertisements to the customer on behalf of the vendor based upon the advertisement campaign rules in response to the detection. The first and second communications devices can be the same or different, and can each correspond to a server or a mobile device operated by the customer.

### CLAIM OF PRIORITY UNDER 35 U.S.C. §119

The present application for patent claims priority to Provisional Application No. 61/566,897 entitled “SELECTIVELY PRESENTING ADVERTISEMENTS TO A CUSTOMER OF A SERVICE BASED ON A PLACE MOVEMENT PATTERN PROFILE”, filed Dec. 5, 2011, and assigned to the assignee hereof and hereby expressly incorporated by reference herein.

### BACKGROUND OF THE INVENTION

1. Field of the Invention

Embodiments of the invention relate to selectively presenting advertisements to a customer of a service based on a place movement pattern profile.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data, Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN) or radio access network (RAN), which is generally a packet data network using standard Internet Engineering Task Force (IETF) based protocols that support methods for differentiating traffic based on Quality of Service (QoS) requirements. Therefore, the Node Bs generally interact with UEs through an over the air interface and with the RAN through Internet Protocol (IP) network data packets.

### SUMMARY

In an embodiment, a first communications device monitors movement of a customer that subscribes to a service of a vendor, determines, based on the monitoring, a list of places that are habitually visited by the customer within a threshold period of time of each other, and generates a place movement pattern profile (PMPP). In another embodiment, a second communications device determines advertisement campaign rules for presentation of advertisements for the service based on the PMPP, detects that the customer is engaged in a visit to the list of places in a manner consistent with the PMPP, and delivers advertisements to the customer on behalf of the vendor based upon the advertisement campaign rules in response to the detection. The first and second communications devices can be the same or different, and can each correspond to a server or a mobile device operated by the customer.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates an example of the wireless communications system of FIG. 1 in more detail.

FIG. 3 is an illustration of a user equipment (UE) in accordance with at least one embodiment of the invention.

FIG. 4 illustrates a communication device 400 that includes logic configured to perform functionality.

FIG. 5 illustrates a process of presenting advertisements to one or more customers of at least one service in accordance with an embodiment of the present invention.

FIG. 6A illustrates examples of a portion of the process of FIG. 5 related to subscribing to an advertising-related service in accordance with an embodiment of the invention.

FIG. 6B illustrates an example of a portion of the process of FIG. 5 related to generating a place movement pattern profile in accordance with an embodiment of the invention.

FIG. 6C illustrates an example of a portion of the process of FIG. 5 related to generating a place movement pattern profile in accordance with another embodiment of the invention.

FIG. 6D illustrates an example of a portion of the process of FIG. 5 related to classifying places within a place movement pattern profile in accordance with an embodiment of the invention.

FIG. 6E illustrates an example of a portion of the process of FIG. 5 related to a configuration utility for advertisement campaign rules in accordance with an embodiment of the invention.

FIG. 6F illustrates examples of a portion of the process of FIG. 5 related to presenting advertisements to target customers in accordance with an embodiment of the invention.

FIG. 7 illustrates an example implementation of FIG. 5 in accordance with an embodiment of the invention.

FIG. 8 illustrates a continuation of the process of FIG. 7 in accordance with an embodiment of the invention.

FIG. 9A illustrates a continuation of the process of FIG. 7 in accordance with another embodiment of the invention.

FIG. 9B illustrates a continuation of the process of FIG. 7 in accordance with another embodiment of the invention.

FIG. 10 illustrates an example implementation of FIG. 5 in accordance with another embodiment of the invention.

FIG. 11A illustrates a continuation of the process of FIG. 10 in accordance with another embodiment of the invention.

FIG. 11B illustrates a continuation of the process of FIG. 10 in accordance with another embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

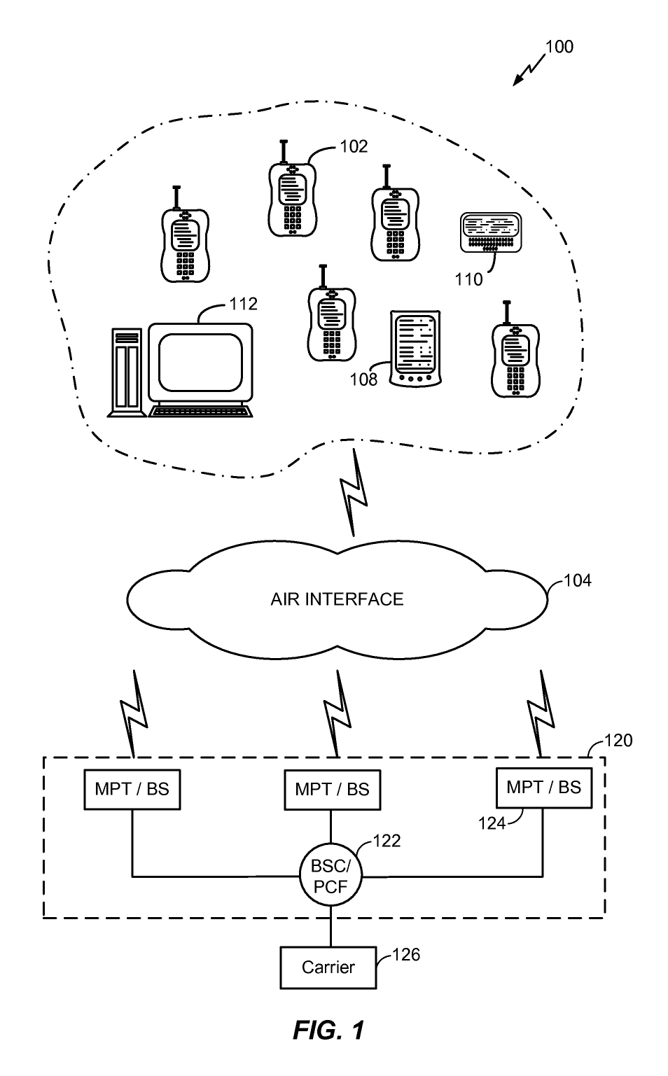

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal,” “AT,” “wireless device,” “client device,” “mobile terminal,” “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

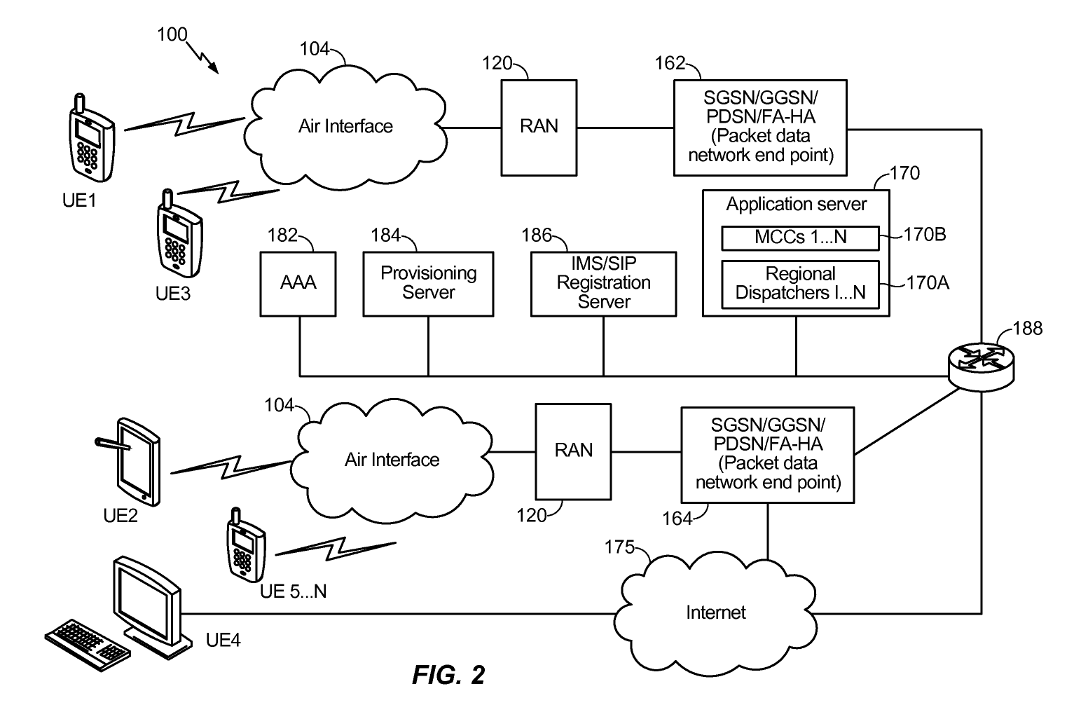

FIG. 2 illustrates an example of the wireless communications system 100 of FIG. 1 in more detail. In particular, referring to FIG. 2, UEs 1 . . . N are shown as connecting to the RAN 120 at locations serviced by different packet data network end-points. The illustration of FIG. 2 is specific to W-CDMA systems and terminology, although it will be appreciated how FIG. 2 could be modified to conform with various other wireless communications protocols (e.g., LTE, EV-DO, UMTS, etc.) and the various embodiments are not limited to the illustrated system or elements.

UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. The application server 170 is illustrated as including one or more media control complexes (MCCs) 1 . . . N 170B, and one or more regional dispatchers 1 . . . N 170A. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2, UEs 1, 3 and 4 . . . N are illustrated as wireless cell-phones, UE 2 is illustrated as a wireless tablet- and/or laptop PC. However, in other embodiments, it will be appreciated that the wireless communication system 100 can connect to any type of UE, and the examples illustrated in FIG. 2 are not intended to limit the types of UEs that may be implemented within the system.

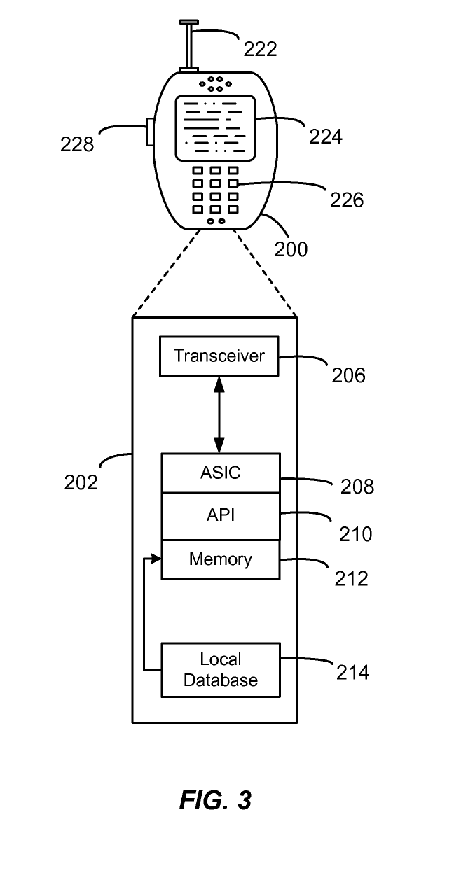

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), 3GPP Long Term Evolution (LTE) or other protocols that may be used in a wireless communications network or a data communications network. Accordingly, the illustrations provided herein are not intended to limit the embodiments of the invention and are merely to aid in the description of aspects of embodiments of the invention.

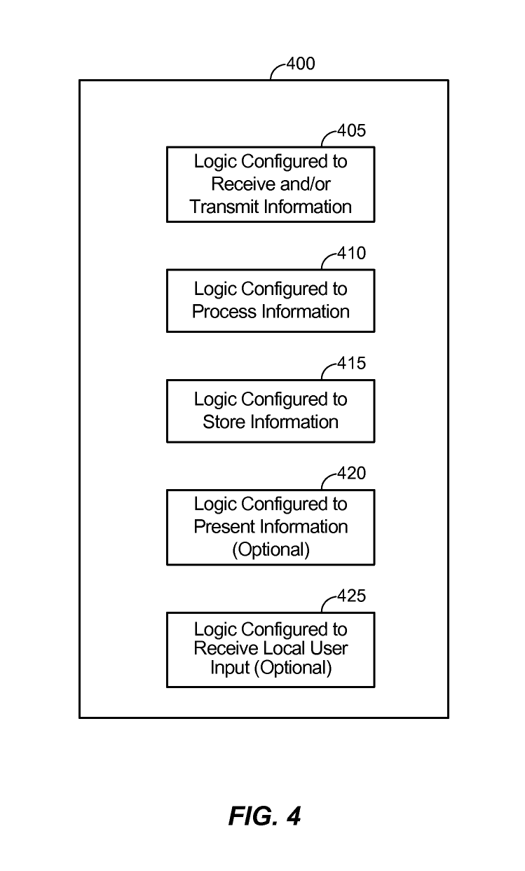

FIG. 4 illustrates a communication device 400 that includes logic configured to perform functionality. The communication device 400 can correspond to any of the above-noted communication devices, including but not limited to UEs 102, 108, 110, 112 or 200, Node Bs or base stations 120, the RNC or base station controller 122, a packet data network end-point (e.g., SGSN 160, GGSN 165, a Mobility Management Entity (MME) in Long Term Evolution (LTE), etc.), any of the servers 170 through 186, etc. Thus, communication device 400 can correspond to any electronic device that is configured to communicate with (or facilitate communication with) one or more other entities over a network.

Referring to FIG. 4, the communication device 400 includes logic configured to receive and/or transmit information 405. In an example, if the communication device 400 corresponds to a wireless communications device (e.g., UE 200, Node B 124, etc.), the logic configured to receive and/or transmit information 405 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., SGSN 160, GGSN 165, application server 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 200 as shown in FIG. 3, the logic configured to present information 420 can include the display 224. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 200 as shown in FIG. 3, the logic configured to receive local user input 425 can include the display 224 (if implemented a touch-screen), keypad 226, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 405. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

It will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

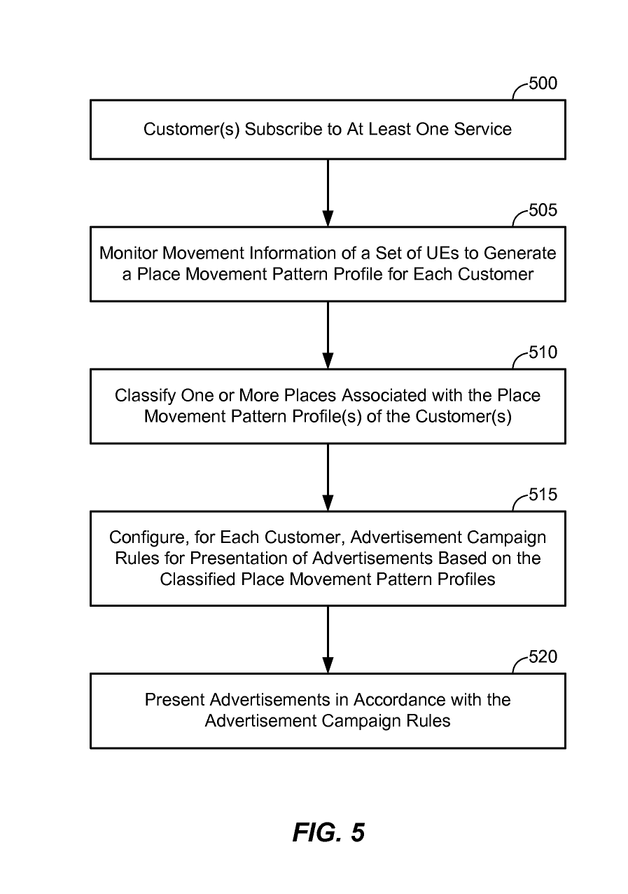

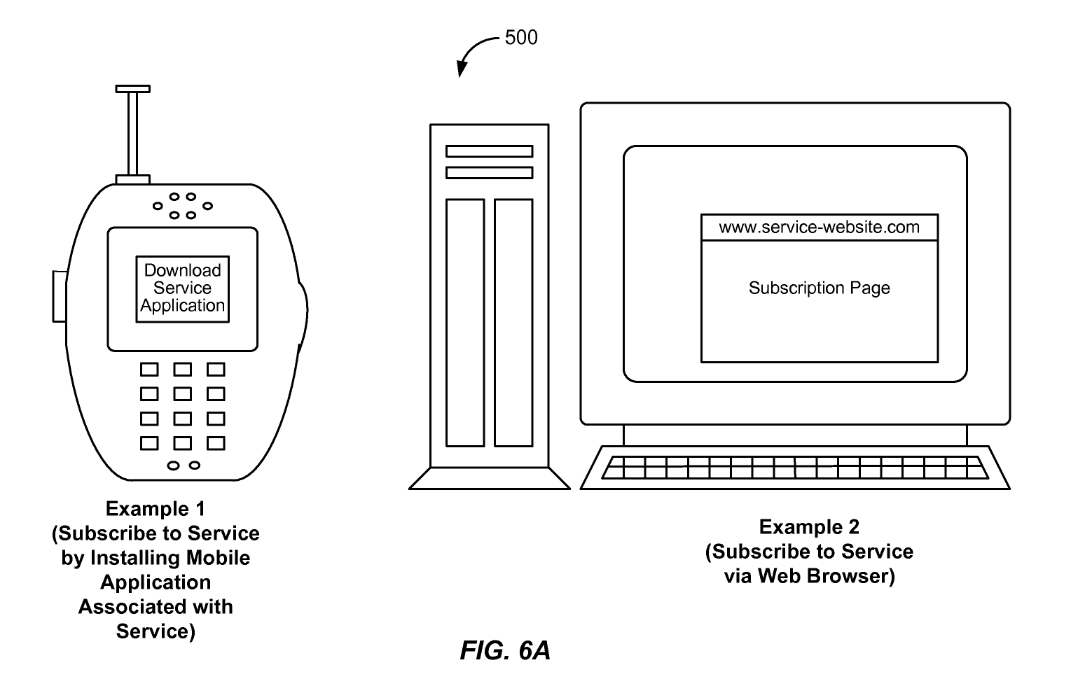

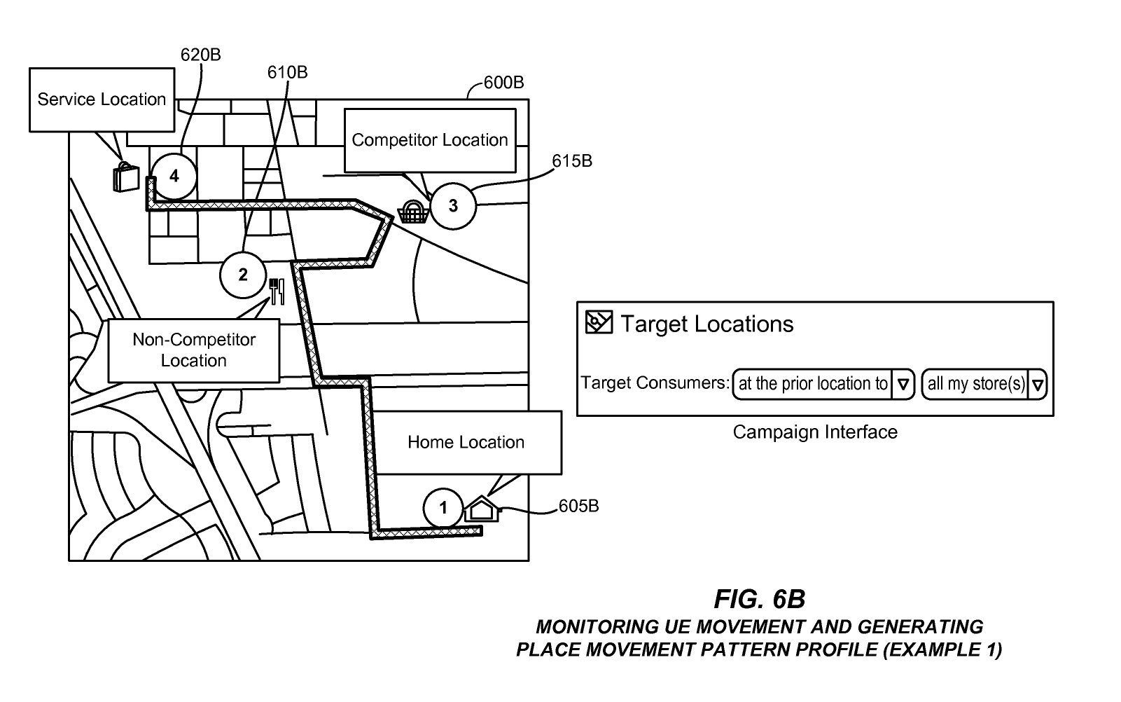

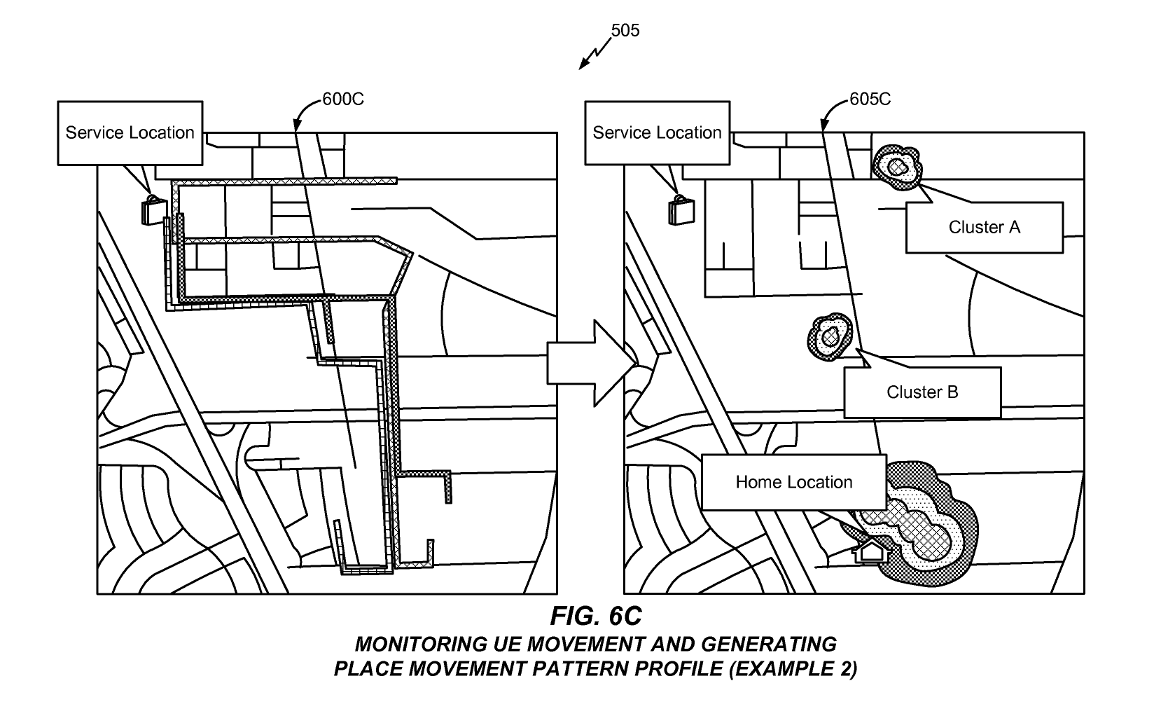

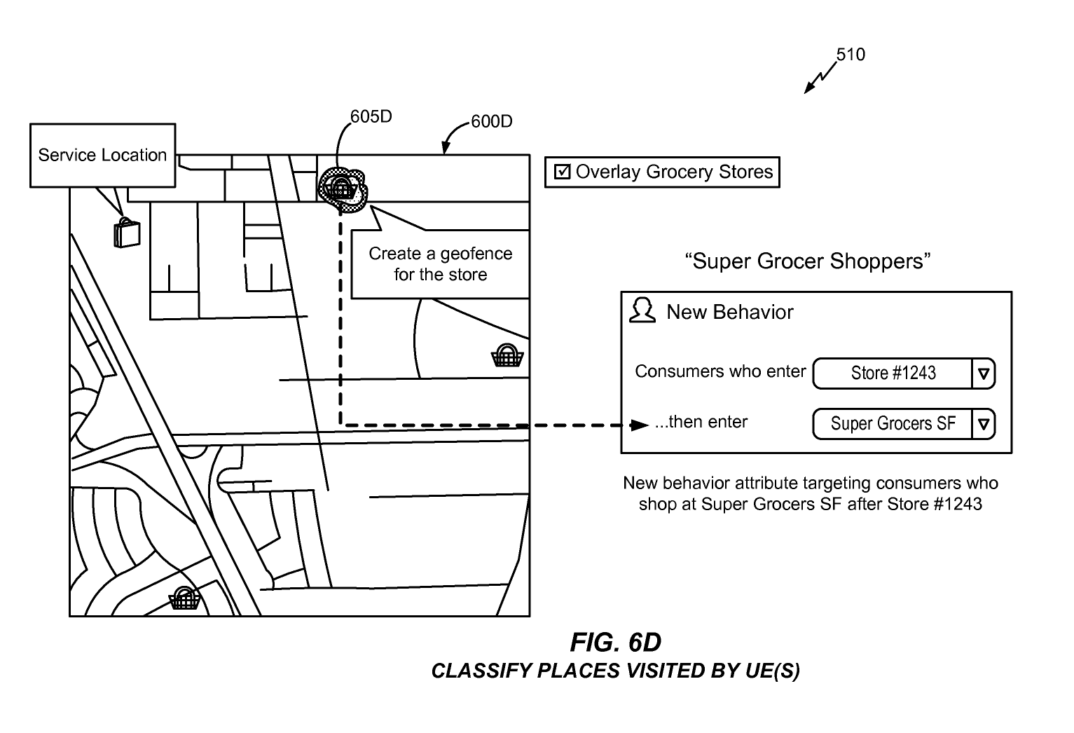

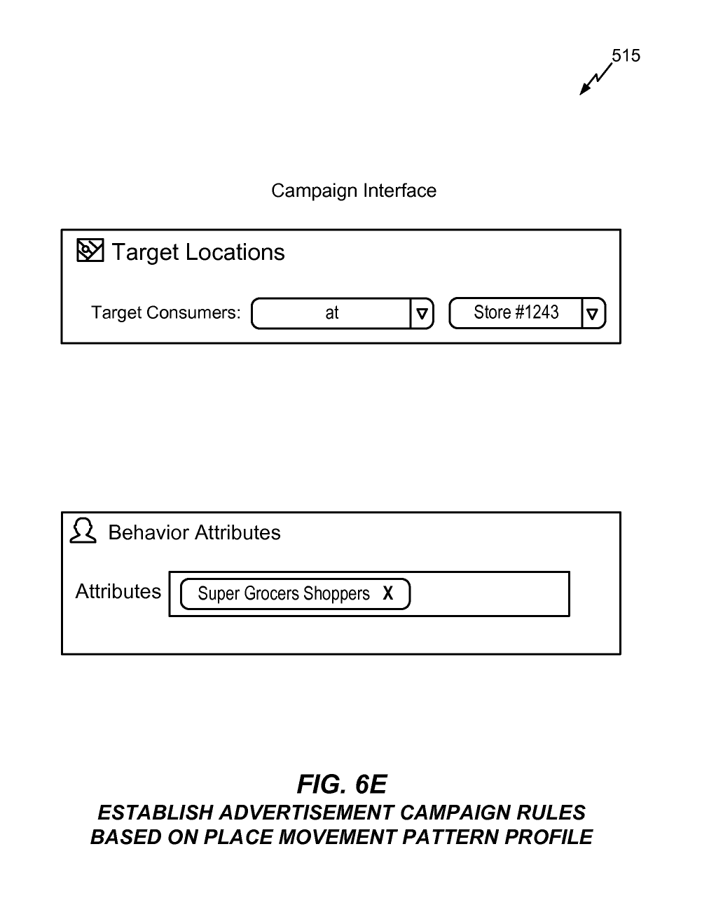

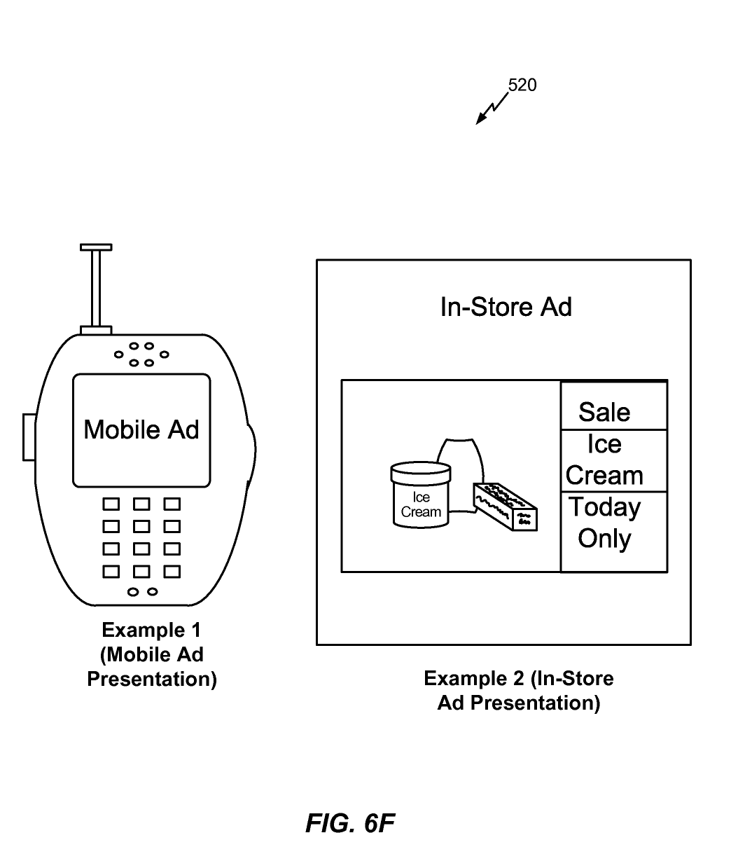

FIG. 5 illustrates a process of presenting advertisements to one or more customers of at least one service in accordance with an embodiment of the present invention. Below, FIG. 5 is described with respect to FIGS. 6A through 6F, which each illustrate examples of portions of the process of FIG. 5.

Referring to FIG. 5, a set of customers subscribe to at least one service (e.g., a Walmart advertising service, a Best Buy advertisement service, etc.), 500. As shown in Example 1 of FIG. 6A, the customer subscription operation of 500 can include a given customer downloading a service-specific mobile application to his/her UE. Alternatively, as shown in Example 2 of FIG. 6A, the customer subscription operation of 500 can include a given customer navigating to a web-page associated with the service and subscribing to the service via the web-page. Alternatively, while not shown in FIG. 6A, the set of customers can subscribe to the at least one service implicitly.

Referring to FIG. 5, assume that subscribing to the at least one service in 500 provides authorization for monitoring location movement associated with the set of subscribed customers. Under this assumption, a given application server (e.g., such as application server 170, discussed above), which is configured to manage advertisement campaign information for a plurality of services, monitors movement information associated with a set of UEs controlled by the set of subscribed customers in order to generate a place movement pattern profile for each UE, 505. Alternatively, while not shown in FIG. 5, it is also possible that each UE in the set of UEs could independently generate its own place movement pattern profile and then report its place movement pattern profile to the given application server and/or a target service controlled by a given service directly.

As used herein, the place movement pattern profile reflects locations to which a particular customer or set of customers have traveled “habitually” (e.g., on most Sunday afternoons between 2 PM and 6 PM, etc.). As will be discussed below in more detail, the place movement pattern profile can be refined further by classifying these locations with an indication of their function and/or relevance to the set of customers (e.g., grocery store, gas station, library, shopping mall, etc.). In an example, the place movement pattern profile can include a non-ordered list of places, as shown below in Table 1:

TABLE 1
Example of Non-Ordered Place Movement Pattern Profile

| | | | Store | Address or Geographic |
|---|---|---|---|---|
| | Place Name | Store Type | Number | Location |
| A | Walmart | Grocery; | #1234 | 1 Walmart Drive, San Diego, |
| | | Electronics; | | CA |
| | | Pharmacy | | |
| B | Best Buy | Electronics | #139 | 7 Best Buy Boulevard, San |
| | | | | Diego, CA |
| C | Trader Joe's | Grocery | #112 | 9 Trader Joe's St., San Diego, |
| | | | | CA |
| D | CVS | Pharmacy | #139 | 4 CVS Lane, San Diego, CA |
| E | Customer's | N/A | N/A | 7 Home Place, San Diego, CA |
| | Home | | | |

As shown in Table 1, the non-ordered place movement pattern profile includes a set of locations or places that are visited by a particular customer or set of customers at a particular frequency (e.g., each Sunday, etc.), for a particular duration (e.g., for more than 20 minutes on average per visit), at which the customer spends above a threshold amount of money (e.g., $50, $150, etc.) and/or in accordance with some other metric. The example non-ordered place movement pattern profile shown above in Table 1 does not account for the order in which the respective places are visited by the customer on a particular trip or in a particular time period. As will be discussed below in more detail, the non-ordered place movement pattern profile shown in Table 1 can be generated based on historical movement patterns of the particular customer or set of customers, and can be used to project or predict future movement patterns of the particular customer or set of customers.

Alternatively, the place movement pattern profile can include an ordered list of places that reflect a particular order that a customer or set of customers is expected to visit particular places in a temporally relevant period (e.g., within an hour, a few hours, a day, etc.), as shown in below in Table 2:

TABLE 2
Example of Ordered Place Movement Pattern Profile

| | | | | | Projected of |
|---|---|---|---|---|---|
| | | | | Address or | Visitation |
| | Place | | Store | Geographic | Order on |
| | Name | Store Type | Number | Location | Sundays |
| A | Walmart | Grocery; | #1234 | 1 Walmart Drive, | 4 |
| | | Electronics; | | San Diego, CA | |
| | | Pharmacy | | | |
| B | Best Buy | Electronics | #139 | 7 Best Buy | 3 |
| | | | | Boulevard, | |
| | | | | San Diego, CA | |
| C | Trader | Grocery | #112 | 9 Trader | 5 |
| | Joe's | | | Joe's St., | |
| | | | | San Diego, CA | |
| D | CVS | Pharmacy | #139 | 4 CVS Lane, | 2 |
| | | | | San Diego, CA | |
| E | Custom- | N/A | N/A | 7 Home Place, | 1; 6 |
| | er's | | | San Diego, CA | |
| | Home | | | | |

As shown in Table 2, the ordered place movement pattern profile is similar to the non-ordered place movement pattern profile from Table 1 except that the ordered place movement pattern profile further includes a visitation order prediction for Sundays. In other words, the ordered place movement pattern profile attempts to project or predict the order in which the customer or set of customers will visit places A through E on a Sunday (e.g., when the customer(s) are performing their weekend errands, etc.). As shown in Table 2, the customer(s) leave their homes (1) and travel to CVS (2), then Best Buy (3), then Walmart (4), then Trader Joe's (5) and then returns home (6). As will be appreciated, different customers most likely live in different homes. The “home” abstraction in E of Tables 1 and 2 therefore represent an abstraction that can apply to customers of different homes; i.e., places can be defined by their relevance to their respective customers and not their geographic positions, in other words. As will be discussed below in more detail, the ordered place movement pattern profile shown in Table 2 can be generated based on historical movement patterns of the particular customer or set of customers, and can be used to project or predict future movement patterns of the particular customer or set of customers.

FIG. 6B illustrates an example of the location tracking that can occur at 505 for an individual UE in conjunction with generating the place movement pattern profile in accordance with an embodiment of the present invention. As shown in FIG. 6B, a map 600B is shown that includes a place denoted as a first location 605B (i.e., a home of the customer controlling the UE), a second location 610B (e.g., an eatery or restaurant), a third location 615B and a fourth location 620B that corresponds to a store associated with a given service to which the UE has subscribed. The numbering of the respective locations in FIG. 6B denotes an ordered place movement pattern profile (e.g., similar to Table 2, above) in the sense that the UE travels between the locations in a sequential order. In FIG. 6B, this means the UE starts at the first location 605B, moves to the second location 610B for a period of time, then moves to the third location 615B for a period of time and finally arrives at the fourth location 620B. Accordingly, the place movement pattern profile can convey sequential route and/or time information (i.e., sequential place movement or progression) instead of mere location information.

FIG. 6C goes on to illustrate location tracking that can occur at 505 for multiple UEs in conjunction with generating the place movement pattern profile in accordance with an embodiment of the present invention. As shown in 600C of FIG. 6C, location movements associated multiple UEs are shown overlaid with each other. Then, in 605C, a “heatmap” is generated that shows “places” where the multiple UEs appear to converge towards at different times. In an example, the place pattern movement profile can be configured to include a set of places, or clusters, as shown in 605C either for an individual UE or for a group of UEs that share similar movement patterns (and/or shopping habits). In 605C of FIG. 6C, the heatmap shows a set of clusters (or places) that have been visited by the UEs tracked from 600C. As shown in FIG. 6C, the order in which the UEs move between the clusters is not shown explicitly, such that 605C represents an example of a non-ordered place movement pattern profile, as discussed above with respect to Table 2 for example. Once the heatmap is generated and the clusters are known, it may be assumed that UEs which are located at a particular cluster are interested in a product or service for that cluster (e.g., if the cluster corresponds to a Walmart and surrounding parking lot, a UE's detection at the cluster may be used to infer that the UE is shopping at Walmart). Likewise, if a UE is not located at a known cluster, it may be assumed that the UE is either traveling between clusters or is engaged in non-categorical travel. In FIG. 6C, the illustrated clusters include clusters A, B and a home location cluster. The home location cluster can correspond to a specific address, or alternatively to a generalized geographic area that is representative of a residential area (e.g., a home development, condominium complex, etc.). The heatmap 605C can thereby illustrate that a group of dwellers in the home location cluster habitually travel to a grocery store (e.g., Cluster A) and a pharmacy (e.g., Cluster B), and advertisement campaign rules (described below in more detail) can be generated to steer this group of dwellers to a separate service location.

Turning back to FIG. 5, at 510, the given application server classifies one or more places associated with the place movement pattern profile(s) of the set of UEs. For example, the given application server can define geofences for other services (e.g., stores) that compete with one of the set of customers' subscribed services. For example, assume that the set of customers each subscribe to a service associated with Walmart, and that Walmart deems Trader Joe's to be a competitor for its fresh produce business. In this case, Walmart can define geofences for Trader Joes' such that locations in a given proximity to one of the Trader Joes' locations can be classified specifically as Trader Joes or more generically as a “grocery competitor”. FIG. 6D illustrates this aspect whereby a map 600D is illustrated with a geofence positioned around a competing grocery store location 605D. The classification of a particular location or place can then be added to the place pattern movement profile as shown above with respect to Tables 1 and 2.

Referring to FIG. 5, at 515, the given application server provides the place movement pattern profile(s) associated with the set of subscribed customers to one or more services (or vendors), and each service (or vendor) then uses the place movement pattern profiles to configure advertisement campaign rules for each of its respective subscribed customers among the set of subscribed customers. In particular, the vendor can mine data from a given place movement pattern profile that is directly or indirectly related to one or more of the vendor's competitors, and the configured advertisement campaign rules can be established so as to benefit the vendor (possibly at the expense of the one or more competitors within the given place movement pattern profile). For example, if the set of subscribed customers subscribe to a Walmart advertising service and a subset of the subscribed customers are associated with a non-ordered place movement pattern profile that includes an electronic store competitor (e.g., Best Buy), then the advertisement campaign rules for the subset of subscribed customers can include targeted delivery of electronics coupons related to Walmart's electronic equipment. In another example, if the set of subscribed customers subscribe to a Walmart advertising service and a subset of the subscribed customers are associated with an ordered place pattern movement profile whereby the subset of subscribed customers travel to Trader Joes (i.e., a competitor with Walmart's grocery service) before Walmart each Sunday afternoon, the advertisement campaign rules for the subset of subscribed customers can include delivering advertisements that advertise Walmart's groceries to the subset of subscribed customers before the subset of subscribed customers arrives at Trader Joes and/or during the subset of UEs' visit to Trader Joes. More examples of advertisement campaign rules will be provided below. FIG. 6E illustrates an example campaign interface tool for implementing 515 of FIG. 5. As shown in FIG. 6E, an operator can use the place movement pattern profile to designate a group of customers as “Super Grocers Shoppers” (e.g., customers that buy groceries at multiple stores). The operator can then select the “Super Grocers Shoppers” group, and can then set up an advertisement delivery trigger that delivers advertisements to the members of this group when these customers are determined to be located at Store #1243 (e.g., which can denote a store controlled by the service itself or a competing service).

After configuring the advertisement campaign rules in 515, advertisements are presented to the set of subscribed customers controlling in accordance with the associated advertisement campaign rules, 520. FIG. 6F illustrates examples of the advertisement presentation that occurs at 520. As shown in Example 1 of FIG. 6F, the advertisement can be presented by a target UE being operated by a target customer for the advertisement. Alternatively, as shown in Example 2 of FIG. 6F, the advertisement can be presented by an in-store presentation device in proximity to a target customer for the advertisement.

Referring to FIG. 5, the place movement pattern profiles generated at 510 can be used to establish a plurality of different advertisement campaign rules for different services (or vendors) in 515. For example, an ordered place movement pattern profile may be indicative that a particular UE or a group of UEs typically leave their house on Sunday morning and travel sequentially to (i) a church, (ii) a breakfast eatery, (iii) a shopping mall and (iv) a movie theater. In this case, the ordered place pattern movement profile may be used to provide advertisements for a first service associated with a breakfast eatery and a second service associated with a movie theater. In this example, a first advertisement campaign rule can trigger delivery of an advertisement for the first service (breakfast eatery) to the target customer's UE while the target customer is leaving church, and an advertisement for the second service (movie theater) can be delivered to the target customer's UE while the target customer is at the shopping mall, for example. Thus, a single ordered place movement pattern profile can be re-used for multiple services and/or multiple advertisement campaigns. It will be appreciated that similar example implementations can be used with respect to non-ordered place movement pattern profiles as well.

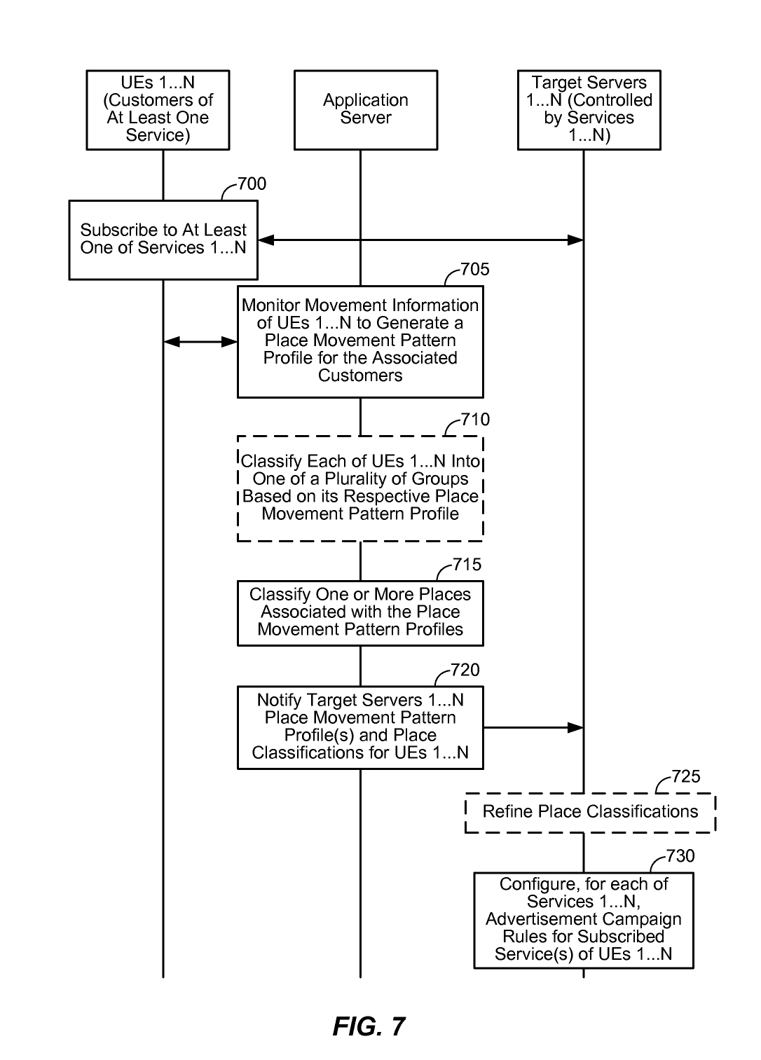

FIG. 7 illustrates an example implementation of 500 through 515 of FIG. 5 in accordance with an embodiment of the invention. Referring to FIG. 7, assume that a set of customers that are operating a respective set of UEs 1 . . . N each subscribe to at least one of services 1 . . . N, where N≧1, 700 (e.g., similar to 500 of FIG. 5 and/or FIG. 6B). In an example, the services 1 . . . N can correspond to advertisement services associated with a retailer, such as Walmart, Best Buy, etc. The given application server is notified of the service subscription(s) from 700 and begins to monitor movement information associated with UEs 1 . . . N to generate a place movement pattern profile for their associated customers, 705 (e.g., similar to 505 of FIG. 5 and/or FIG. 6B or 6C). In an example, the monitoring in 705 can be based upon periodic or event-triggered location reports sent by UEs 1 . . . N to the given application server that report information related to the locations of UEs 1 . . . N. The place movement pattern profile generated at 705 can correspond to an ordered or non-ordered place movement pattern profile, as discussed above with respect to Tables 1 and 2, respectively.

Referring to FIG. 7, the given application server optionally classifies each of the customers associated with UEs 1 . . . N into one of a plurality of groups based on their respective place movement pattern profiles, 710. For example, customers associated with similar place movement pattern profiles can be grouped together and then associated with a group-specific place movement pattern profile instead of a customer-specific place pattern movement profile. The heatmap 605C shown in FIG. 6C is an example of a group-specific place movement pattern profile because the heatmap is representative of places at which multiple customers have visited.

Referring to FIG. 7, the given application server classifies one or more places associated with the place movement pattern profile(s) (e.g., group-specific or customer-specific) associated with UEs 1 . . . N, 715 (e.g., similar to 510 of FIG. 5 and/or FIG. 6D). For example, the given application server can define geofences for other services (e.g., stores) that compete with one or more of services 1 . . . N.

Referring to FIG. 7, the given application server sends, to target servers 1 . . . N associated with services 1 . . . N, the place movement pattern profile(s) associated with UEs 1 . . . N, as appropriate, 720. For example, if UEs 1 . . . 7 subscribe to Service 1 and UEs 4 . . . 9 subscribe to Service 2, Service 1 receives the place movement pattern profile(s) associated with UEs 1 . . . 7 and Service 2 receives the place movement pattern profile(s) associated with UEs 4 . . . 9 in 720.

Referring to FIG. 7, the target servers 1 . . . N can optionally refine the place classifications from 715, 725. If 725 is performed, the place classification from 715 functions as an initial or default place classification. The target servers 1 . . . N may have access to information to specialized competitor knowledge and/or other information that can permit enhanced classification refinement to the respective places. For example, the given application server can classify a particular place as being a grocery store and the target servers 1 . . . N can further classify the particular place as being an organic grocery store. In an example, the refinement to the place classifications at 725 can include customization of icons representing the places in the place movement pattern profile (e.g., a Trader Joe's icon is configured for presentation instead of a more generic grocery store icon, etc.). Again, 725 is an optional step, and in other embodiments the target servers 1 . . . N can simply rely upon the given application server's attempt to classify the places in the place movement pattern profile(s) without further refinement.

The target servers 1 . . . N then configures advertisement campaign rules for the set of customers associated with UEs 1 . . . N on behalf of services 1 . . . N, 730 (e.g., similar to 515 of FIG. 5). It will be appreciated that the advertisement campaign rules can be associated with groups of customers (e.g., if 710 is performed) or with individual UEs based on customer-specific place movement pattern profiles.

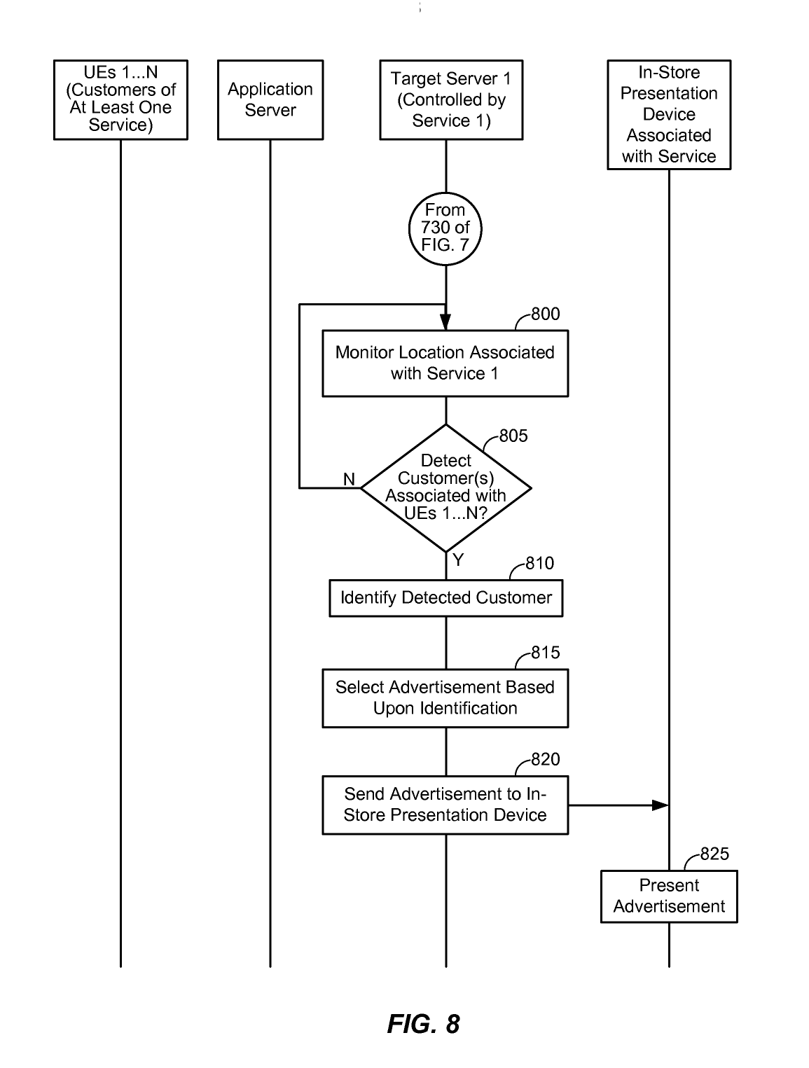

FIG. 8 illustrates a continuation of the process of FIG. 7 in accordance with an embodiment of the invention. Referring to FIG. 8, after a given target server (“target server 1”) associated with a given service (“service 1”) among services 1 . . . N configures its respective advertisement campaign rules for the set of customers that are operating UEs 1 . . . N in 730 of FIG. 7, target server 1 monitors a location associated with service 1, 800. For example, the location associated with service 1 can correspond to a retail location or store such as 620B of FIG. 6B. The location monitoring that occurs at 800 can correspond to any type of monitoring sufficient to indicate when the set of customers are in proximity to the service 1 location or a specific point within the service 1 location at which the set of customers are proximate (e.g., aisle 17 in service 1's retail store, etc.). Accordingly, the location monitoring that occurs at 800 can correspond to GPS or some other UE-position determination scheme, or alternatively can be more localized in nature (e.g., an RFID scan that occurs within the service 1 location itself with respect to UEs 1 . . . N or to some other RFID tag on the set of customers, etc.).

Based on the location monitoring from 800, the target server 1 determines whether any customers associated with UEs 1 . . . N are detected in proximity to the service 1 location, 805. If the target server 1 determines that none of UEs 1 . . . N are detected in proximity to the service 1 location in 805, the process returns to 800 and the target server 1 continues to monitor the service 1 location. Otherwise, if the target server 1 determines that one or more of UEs 1 . . . N are detected in proximity to the service 1 location in 805, the target server 1 identifies the detected customer 810. The identification of 810 can correspond to a UE-specific or customer-specific identification, or alternatively to a group-specific identification (e.g., based on the group classifications from 710 of FIG. 7, in an example). The identification of the customer(s) at 810 can be used to look up their associated place movement pattern profile in 815, which is then used to select a targeted advertisement to be delivered to the identified customer(s). For example, a given customer being detected and identified in association with a place movement pattern profile that indicates that the given customer frequently visits electronic stores coupled with detection of the given customer in an aisle where electronic wares are displayed at service 1 can trigger an advertisement related to electronics to be delivered to the given customer at 815.

After selecting the advertisement in 815, the selected advertisement is sent to an in-store presentation device (e.g., an electronic display or billboard in proximity to the identified customer(s) detected location(s)), 820. The in-store presentation device receives and presents the advertisements, 825. An example of the presentation that occurs at 825 is shown in Example 2 of FIG. 6F.

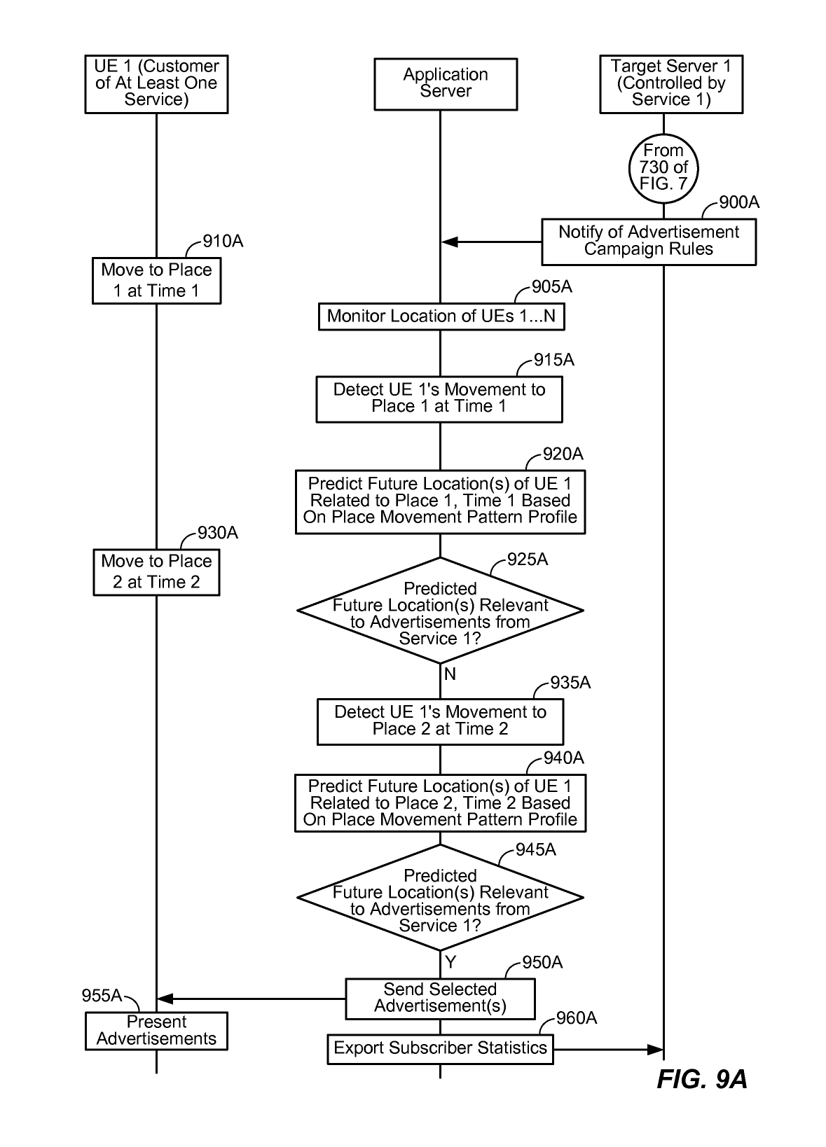

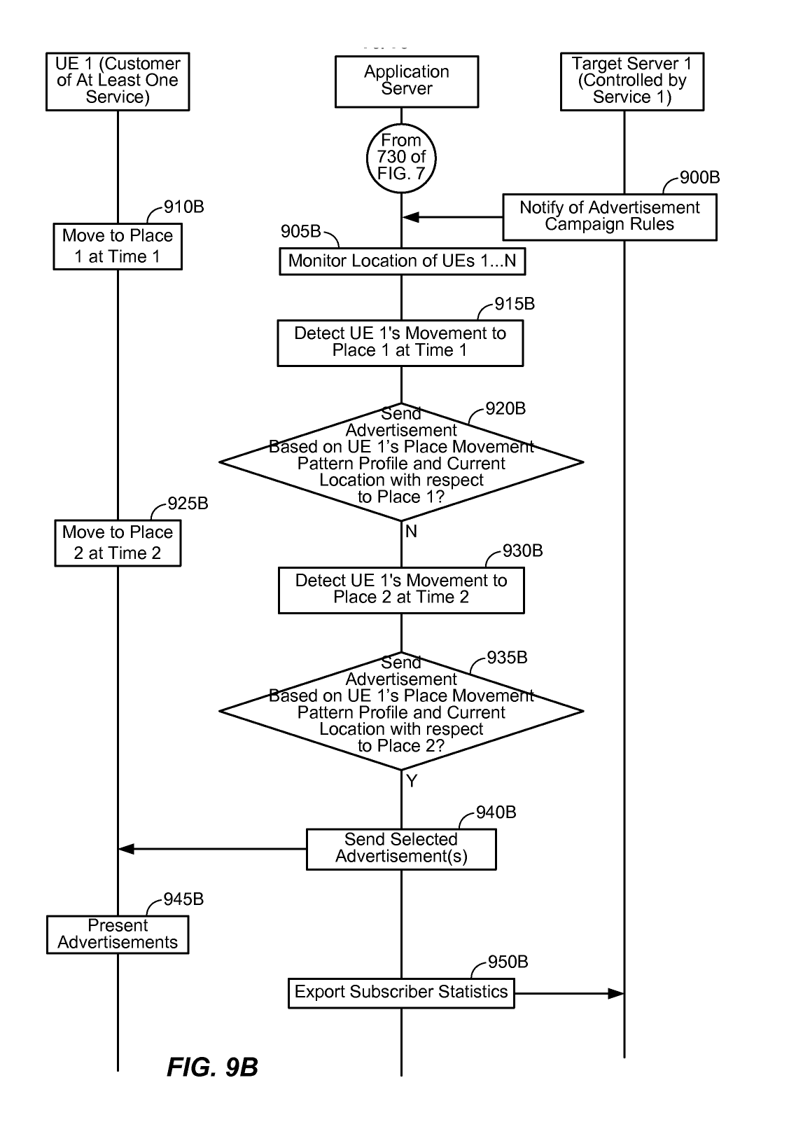

FIG. 9A illustrates a continuation of the process of FIG. 7 in accordance with another embodiment of the invention. Referring to FIG. 9A, after a given target server (“target server 1”) associated with a given service (“service 1”) among services 1 . . . N configures its respective advertisement campaign rules for the set of customers that are operating UEs 1 . . . N in 730 of FIG. 7, target server 1 reports its respective advertisement campaign rules to the given application server, 900A. In the embodiment of FIG. 9A, assume that the place movement pattern profile used to generate the reported advertisement campaign rules from target server 1 corresponds to an ordered place movement pattern profile.

The given application server receives target server 1's advertisement campaign rules and monitors a location associated with a given UE (“UE 1”) among UEs 1 . . . N, 905A. The location monitoring of 905A can correspond to the given application server receiving periodic or event-triggered location reports from UE 1 (e.g., based on GPS, etc.) or via some other location detection mechanism. Unlike 705 of FIG. 7, the location monitoring of 905A is related to targeted delivery of advertisements based on a place movement pattern profile and not merely to generation of the place movement pattern profile. However, while not shown in FIG. 9A, the place movement pattern profiles can also be further updated or refined based on the location monitoring from 905A.

Referring to FIG. 9A, while the given application server is monitoring the location of UE 1, assume that UE 1 moves to place 1 at time 1, 910A, and that the given application server detects UE 1's movement to place 1 at time 1, 915A. In particular, the detection of UE 1's movement to place 1 at time 1 can correspond to an actual detection that UE 1 has entered place 1, or an implicit detection whereby UE 1 is detected in proximity to (or nearby) place 1 and/or is moving away from place 1 but is still close to place 1. Based on the detected movement of UE 1 to place 1 at time 1, the given application server uses UE 1's ordered place movement pattern profile to predict one or more future location(s) of UE 1, 920A. The prediction of 920A can be constrained temporally, such that if time 1 corresponds to Sunday at 2 PM, then the prediction will attempt to predict places that UE 1 is likely to visit in the next 4 hours, 8 hours, etc. Based on the location or place prediction of 920A, the given application server determines whether any of the predicted future locations of UE 1 trigger one or more of the advertisement campaign rules of service 1 (or any of UE 1's other subscribed services), 925A. In the embodiment of FIG. 9A, assume that the predicted future location(s) of UE 1 do not satisfy any of the advertisement campaign rules of service 1.

At some later point in time, while the given application server continues to monitor the location of UE 1, assume that UE 1 moves to place 2 at time 2, 930A, and that the given application server detects UE 1's movement to place 2 at time 2, 935A. In particular, the detection of UE 1's movement to place 2 at time 2 can correspond to an actual detection that UE 1 has entered place 2, or an implicit detection whereby UE 1 is detected in proximity to (or nearby) place 2 and/or is moving towards place 2 or is moving away from place 2 but is still close to place 2. Based on the detected movement of UE 1 to place 2 at time 2, the given application server uses UE 1's ordered place movement pattern profile to predict one or more future location(s) of UE 1, 940A. The prediction of 940A can be constrained temporally, such that if time 2 corresponds to Sunday at 4 PM, then the prediction will attempt to predict places that UE 1 is likely to visit in the next 3 hours, 7 hours, etc. Based on the location or place prediction of 940A, the given application server determines whether any of the predicted future locations of UE 1 trigger one or more of the advertisement campaign rules of service 1 (or any of UE 1's other subscribed services), 945A.

In the embodiment of FIG. 9A, assume that the predicted future location(s) of UE 1 satisfies one or more advertisement campaign rules of service 1. For example, UE 1 may be at the gym, and the ordered place movement pattern profile may predict that UE 1 is likely to travel from the gym to an eatery or restaurant. If service 1 corresponds to a restaurant, the predicted future location of UE 1 traveling to a restaurant may trigger an advertisement campaign rule for delivering advertisements for service 1's restaurant to customers likely to be hungry soon. In another example, UE 1 may be at service 1's location, and the ordered place movement pattern profile may predict that UE 1 is likely to travel from the service 1 location to a competing electronics store. If service 1 also sells electronics, the predicted future location of UE 1 traveling to a competing electronics store may trigger an advertisement campaign rule for delivering advertisements for service 1's electronics equipment to UE 1 to encourage UE 1's operator to purchase their electronics equipment at the service 1 location instead of the competing electronics store. Accordingly, the advertisement campaign rules can leverage the ordered place movement pattern profile to delivery advertisements to a target UE based on the target UE being projected to travel to or from a given service's location. In another example, the predicted future location(s) do not have to be directly owned or operated by service 1, but could instead be indirectly related to service 1 via an association with products and/or services of service 1. For example, the predicted future location(s) of UE 1 may include a beach that is not owned or operated by service 1. However, service 1 may provide products (e.g., surfboards, tanning lotion, etc.) or services (e.g., surfboard waxing, body waxing, swim lessons, etc.) associated with the beach. Thus, the relationship between the predicted future location(s) of UE 1 and service 1 for satisfying the advertisement campaign rules can be based to steer customers away from competing locations and/or to anticipate the products and/or services that will be useful to the types of activities (e.g., swimming, sunbathing, etc.) that UE 1's user is likely to engage in at the predicted future location(s).

After determining that one or more of UE 1's predicted future locations are sufficient to trigger or satisfy one of the advertisement campaign rules of service 1 in 945A, one or more advertisements associated with service 1 are selected and sent to UE 1, 950A, and UE 1 presents the advertisement(s) in 955A (e.g., as in Example 1 from FIG. 6F). Further, the given application server can export subscriber statistics to the target server 1 reporting information such as which advertisements were delivered to UE 1, an updated place movement pattern profile associated with UE 1, and so on, 960A.

FIG. 9B illustrates a continuation of the process of FIG. 7 in accordance with another embodiment of the invention. Referring to FIG. 9B, after a given target server (“target server 1”) associated with a given service (“service 1”) among services 1 . . . N configures its respective advertisement campaign rules for the set of customers that are operating UEs 1 . . . N in 730 of FIG. 7, target server 1 reports its respective advertisement campaign rules to the given application server, 900B. In the embodiment of FIG. 9B, unlike FIG. 9A, assume that the place movement pattern profile used to generate the reported advertisement campaign rules from target server 1 corresponds to a non-ordered place movement pattern profile. In other words, the order in which places are visited by UE 1 is not a factor in presenting advertisements at UE 1 in the embodiment of FIG. 9B.

The given application server receives target server 1's advertisement campaign rules and monitors a location associated with a given UE (“UE 1”) among UEs 1 . . . N, 905B. The location monitoring of 905B can correspond to the given application server receiving periodic or event-triggered location reports from UE 1 (e.g., based on GPS, etc.) or via some other location detection mechanism. Unlike 705 of FIG. 7, the location monitoring of 905B is related to targeted delivery of advertisements based on a place movement pattern profile and not merely to generation of the place movement pattern profile. However, while not shown in FIG. 9B, the place movement pattern profiles can also be further updated or refined based on the location monitoring from 905B.

Referring to FIG. 9B, while the given application server is monitoring the location of UE 1, assume that UE 1 moves to place 1 at time 1, 910B, and that the given application server detects UE 1's movement to place 1 at time 1, 915B. In particular, the detection of UE 1's movement to place 1 at time 1 can correspond to an actual detection that UE 1 has entered place 1, or an implicit detection whereby UE 1 is detected in proximity to (or nearby) place 1 and/or is moving away from place 1 but is still close to place 1. Based on the detected movement of UE 1 to place 1 at time 1, the given application server determines whether UE 1's movement to place 1 at time 1 triggers one or more of the advertisement campaign rules of service 1 (or any of UE 1's other subscribed services), 920B. In the embodiment of FIG. 9B, assume that UE 1's detection at place 1 at time 1 does not satisfy any of the advertisement campaign rules of service 1.

At some later point in time, while the given application server continues to monitor the location of UE 1, assume that UE 1 moves to place 2 at time 2, 925B, and that the given application server detects UE 1's movement to place 2 at time 2, 930B. In particular, the detection of UE 1's movement to place 2 at time 2 can correspond to an actual detection that UE 1 has entered place 2, or an implicit detection whereby UE 1 is detected in proximity to (or nearby) place 2 and/or is moving away from place 2 but is still close to place 2, that UE 1 is moving away from place 1 such that movement towards place 2 is inferred from the ordered list of places in the place movement pattern profile, etc. Based on the detected movement of UE 1 to place 2 at time 2, the given application server determines whether UE 1's movement to place 2 at time 2 triggers one or more of the advertisement campaign rules of service 1 (or any of UE 1's other subscribed services), 935B.

In the embodiment of FIG. 9B, assume that UE 1's detection at place 2 at time 2 satisfies one or more advertisement campaign rules of service 1. For example, the non-ordered place movement pattern profile can be similar to the example shown in the heatmap 605C of FIG. 6C. Accordingly, the non-ordered place movement pattern profile can show that the customer operating UE 1 has a habit of visiting service 1's location and also visiting one or more competitors of service 1 with respect to a given product type or service type. In this example, the advertisement campaign rules for service 1 can include providing advertisements related to given product type or service type in response to a detection that UE 1 is positioned in proximity to the service 1 location or the competitor location(s). For example, if the service 1 location corresponds to a Walmart retail store which sells at least grocery, electronics and pharmacy products and the non-ordered place movement pattern profile indicates that UE 1 also frequently visits a CVS pharmacy, a first advertisement campaign rule can be established for delivering Walmart pharmacy-related advertisements when UE 1 is positioned at the Walmart retail store and a second advertisement campaign rule can be established for delivering Walmart pharmacy-related advertisements when UE 1 is positioned at the CVS pharmacy. In another example, if the service 1 location corresponds to a Walmart retail store which sells at least beach-related products (e.g., sun tan lotion, etc.) and the non-ordered place movement pattern profile indicates that UE 1 also frequently visits a local beach, a first advertisement campaign rule can be established for delivering Walmart beach product-related advertisements when UE 1 is positioned at or nearby the Walmart retail store and a second advertisement campaign rule can be established for delivering Walmart beach product-related advertisements when UE 1 is positioned at the CVS pharmacy (which also sells beach products such as sun tan lotion that may compete with Walmart's beach products). Thus, the relationship between the service 1 location and the locations in the non-ordered place movement pattern profile need not be a direct competitor relationship, but can include locations associated with products and/or services that will be useful to the types of activities (e.g., swimming, sunbathing, etc.) that UE 1's user is likely to engage in at the listed locations. Unlike FIG. 9A, the order in which UE 1 moves between these stores does not necessarily need to be a factor in the advertisement campaign rules.

After determining that UE 1's detection at place 2 at time 2 satisfies one or more advertisement campaign rules of service 1, one or more advertisements associated with service 1 are selected and sent to UE 1, 940B, and UE 1 presents the advertisement(s) in 945B (e.g., as in Example 1 from FIG. 6F). Further, the given application server can export subscriber statistics to the target server 1 reporting information such as which advertisements were delivered to UE 1, an updated place movement pattern profile associated with UE 1, and so on, 950B.

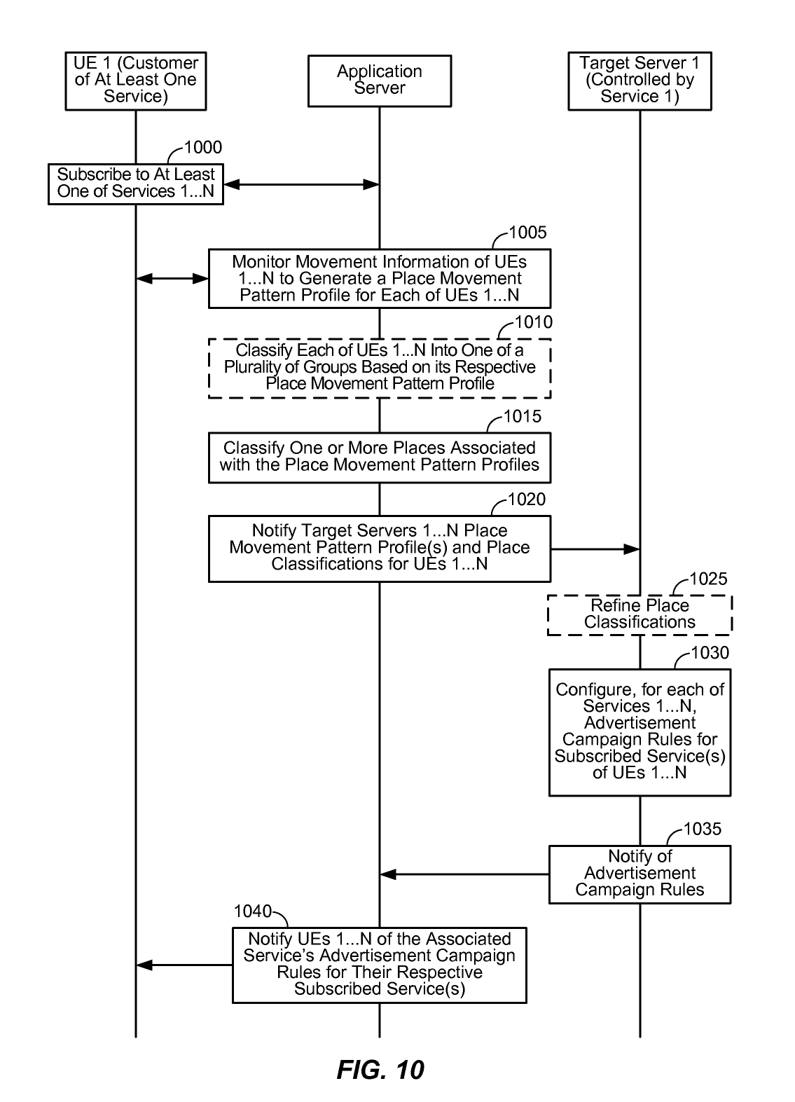

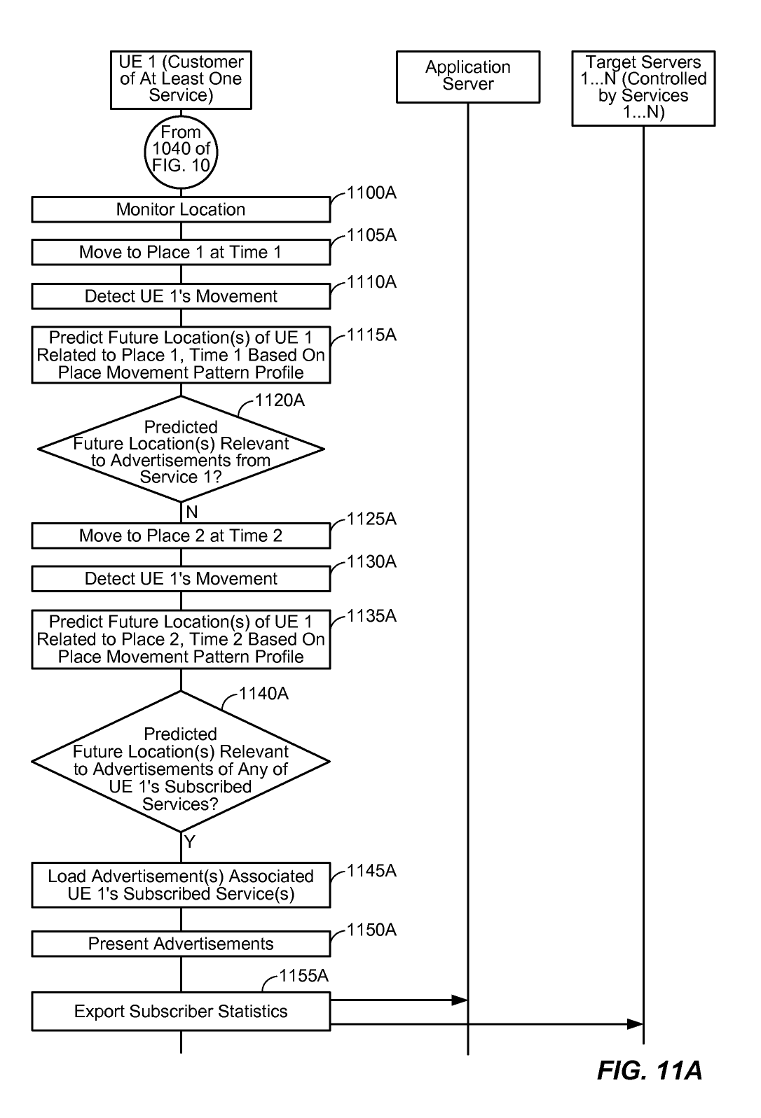

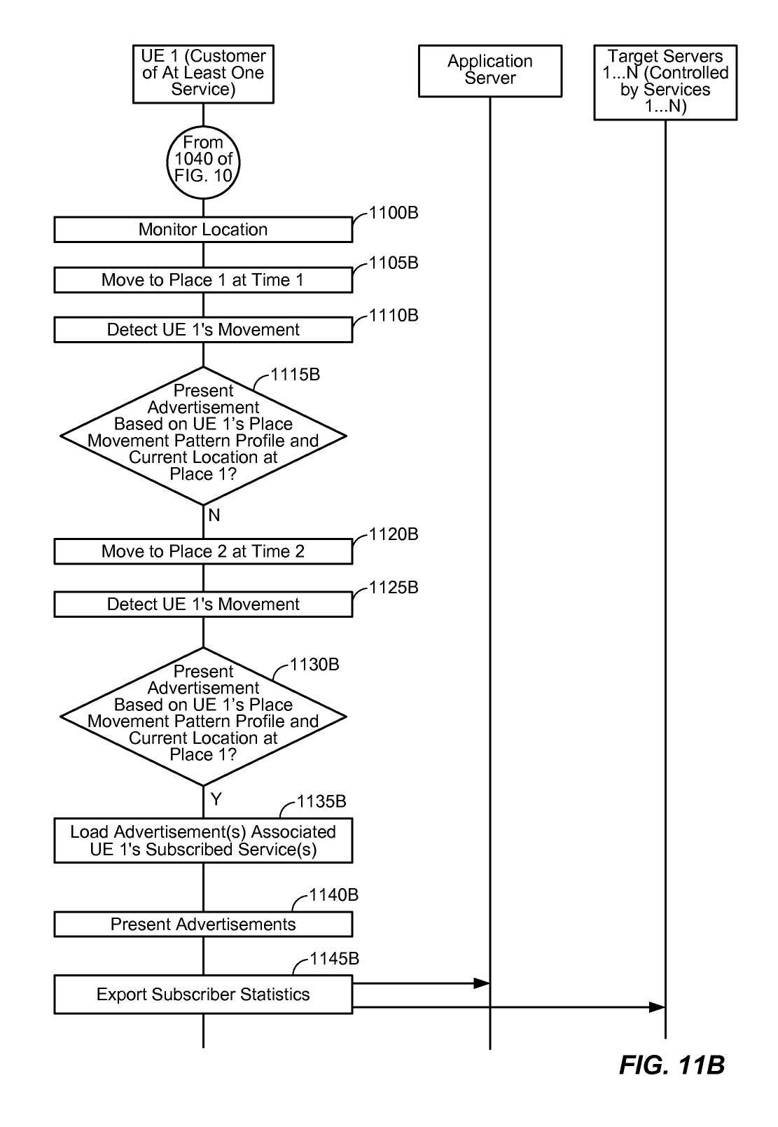

FIG. 10 illustrates another example implementation of 500 through 515 of FIG. 5 in accordance with an embodiment of the invention. 1000 through 1030 are substantially similar to 700 through 730 of FIG. 7, and as such will not be described further for the sake of brevity. After configuring the advertisement campaign rules for the subscribed services of UEs 1 . . . N, the target servers 1 . . . N notify the given application server of the configured advertisement campaign rules, 1035. In the embodiment of FIG. 10, instead of evaluating the advertisement campaign rules on the given application server, the advertisement campaign rules are sent to UEs 1 . . . N for each of their respective subscribed services, 1040. As will be appreciated by one of ordinary skill in the art, FIGS. 7 through 9B are directed to server-side implementations of the process of FIG. 5, whereby a server (e.g., the given application server or one of target servers 1 . . . N) track UE and/or customer locations to trigger targeted advertisements based on campaign advertisement rule based on associated place movement pattern profiles. As will be appreciated from the description of FIGS. 11A and 11B below, notifying the UEs 1 . . . N of the advertisement campaign rules and/or place movement pattern profiles permits enforcement of the advertisement campaign rules at the UEs themselves instead of on the server-side.

FIG. 11A illustrates a continuation of the process of FIG. 10 in accordance with another embodiment of the invention. FIG. 11A is similar to FIG. 9A except that many of the procedures shown in FIG. 9A as executed at the given application server are instead moved to UE 1 in FIG. 11A. In particular, 1100A through 1155A of FIG. 11A substantially correspond to 905A through 960A of FIG. 9A except for being implemented at UE 1 instead of the given application server and 1145A corresponding to a UE-load operation where 950A corresponds to a server-to-UE transfer operation. Accordingly, the detections of 1110A and 1130A are based on UE 1's own detections of its movements instead of location reports sent to the given application server as in 915A and 935A of FIG. 9A, the subscriber statistics exported at 1155A can optionally be sent to both the given application server as well as the target server 1, and so on.

FIG. 11B illustrates a continuation of the process of FIG. 10 in accordance with another embodiment of the invention. FIG. 11B is similar to FIG. 9B except that many of the procedures shown in FIG. 9B as executed at the given application server are instead moved to UE 1 in FIG. 11B. In particular, 1100B through 1145B of FIG. 11B substantially correspond to 905B through 950B of FIG. 9A except for being implemented at UE 1 instead of the given application server and 1135B corresponding to a UE-load operation where 940B corresponds to a server-to-UE transfer operation. Accordingly, the detections of 1110B and 1125B are based on UE 1's own detections of its movements instead of location reports sent to the given application server as in 915B and 930B of FIG. 9A, the subscriber statistics exported at 1145B can optionally be sent to both the given application server as well as the target server 1, and so on.

In the embodiments described above, UE 1 is described as being detected at particular locations. For example, UE 1 is detected at the service 1 location at 805 of FIG. 8, at place 1 at 915A, 915B, 1110A and 1110B of FIGS. 9A, 9B, 11A and 11B, respectively, and at place 2 at 935A, 930B, 1130A and 1125B of FIGS. 9A, 9B, 11A and 11B, respectively. These respective detections can correspond to explicit detections of UE 1 at the respective places, or can alternatively be implicit detections that UE 1 is simply nearby or headed towards respective places (e.g., UE 1 is moving away from place 1 and thereby is presumed to be headed towards place 2 if place 2 comes after place 1 for an ordered place movement pattern profile, etc.). Accordingly, the UE 1's detection relative to a particular place is a broad interpretation that at least implies an availability of UE 1 to visit the particular place, but not necessarily that UE 1 is positioned within the particular place at the moment of detection.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of delivering advertisements, comprising:
determining, for a given customer, advertisement campaign rules for presentation of advertisements for at least one service of a given vendor to which the given customer subscribes based upon a place movement pattern profile of the given customer, wherein the place movement pattern profile includes a list of places that the given customer has habitually visited within a threshold period of time of each other, the list of places including at least one competitor of the given vendor;
detecting that the given customer is engaged in a given visit to the list of places in a manner consistent with the place movement pattern profile; and
delivering advertisements to the given customer on behalf of the given vendor based upon the advertisement campaign rules in response to the detection.

2. The method of claim 1, wherein the list of places is an ordered list of places that indicates an order in which the given customer has habitually visited the list of places.

3. The method of claim 1, wherein the list of places is a non-ordered list of places that does not indicate an order in which the given customer has habitually visited the list of places.

4. The method of claim 1, further comprising:
monitoring movement of the given customer to generate the place movement pattern profile.

5. The method of claim 1, further comprising:
classifying one or more of the listed places within the place movement pattern profile.

6. The method of claim 5, wherein the classifying includes identifying at least one class of products and/or services associated with the one or more listed places and adding the identified class of products and/or services to the place movement pattern profile.

7. The method of claim 6, wherein the at least one class of products and/or services includes multiples classes of products.

8. The method of claim 6, wherein the at least one class of products and/or services includes groceries, restaurants, electronics and/or medical.

9. The method of claim 1,
wherein the detecting includes determining that the given customer is currently located at a given place among the list of places, and
wherein the delivering includes, responsive to the detection, sending at least one advertisement to an in-store presentation device that is controlled by an operator of the given place for presentation to the given customer.

10. The method of claim 1,
wherein the detecting is based on a determination of a current location of the given customer, and
wherein the delivering includes predicting, based on the current location of the given customer, that the given customer will visit at least one place among the list of places within a given period of time, and determining that the predicted at least one place is relevant to at least one advertisement for the at least one service to which the given customer is subscribed.

11. The method of claim 10, wherein the current location indicates that the given customer is moving towards, away from, is nearby and/or is at a given place among the list of places and the detecting detects the given customer's engagement in the visit to the list of places based on the current location's association with the given place.

12. The method of claim 10, wherein the delivering further comprises:
sending, in response to the determination of relevance, the at least one advertisement to a mobile device associated with the given customer for presentation thereon.

13. The method of claim 10, wherein the delivering further comprises:
presenting, in response to the determination of relevance, the at least one advertisement on a mobile device associated with the given customer.

14. The method of claim 10,
wherein the current location indicates that the given customer is moving towards, away from, is nearby and/or is at one of the list of places,
wherein the list of places is an ordered list of places that indicates an order in which the given customer visits the list of places, and
wherein the predicting predicts the predicted at least one place as one or more places that occur later in the order as compared to the place corresponding to the current location.

15. The method of claim 10,
wherein the predicted at least one place is associated with the at least one competitor of the given vendor, and
wherein the delivering delivers the advertisements on behalf of the given vendor in order to steer the given customer towards a different place associated with the given vendor.

16. The method of claim 15, wherein a relationship between the different place and the given vendor is (i) the given vendor owns or operates the different place, or (ii) the given vendor provides products and/or services for one or more types of activities related to the different place.

17. The method of claim 1, wherein the detecting includes:
determining that the given customer is moving towards or away from a given place among the list of places and/or is currently located at or near the given place among the list of places.

18. The method of claim 17, wherein the delivering includes:
sending, in response to the determination of location, at least one advertisement associated with at least one other place among the list of places to a mobile device associated with the given customer for presentation thereon.

19. The method of claim 18, wherein the at least one other place is related to the given vendor.

20. The method of claim 19, wherein the relationship between the at least one other place and the given vendor is (i) the given vendor owns or operates the at least one other place, or (ii) the given vendor provides products and/or services for one or more types of activities related to the at least one other place.

21. The method of claim 17, wherein the delivering further includes:
presenting, in response to the determination of location, at least one advertisement associated with at least one other place among the list of places on a mobile device associated with the given customer.

22. The method of claim 21, wherein the at least one other place is related with the given vendor.

23. The method of claim 22, wherein the relationship between the at least one other place and the given vendor is (i) the given vendor owns or operates the at least one other place, or (ii) the given vendor provides products and/or services for one or more types of activities related to the at least one other place.

24. The method of claim 1, wherein each place is populated in the list of places of the place movement pattern profile based on each place in the list of places corresponding to a distinct geographical area at which a threshold number of users converge at or cluster.

25. The method of claim 1, wherein the determining and delivering are performed at a server.

26. The method of claim 1, wherein the determining and delivering are performed at a mobile device associated with the given customer.

27. A method of delivering advertisements, comprising:
monitoring movement of a given customer that subscribes to at least one service of a given vendor;
determining, based on the monitoring, a list of places that are habitually visited by the given customer within a threshold period of time of each other, the list of places including at least one competitor of the given vendor; and
generating a place movement pattern profile based on the list of places.

28. The method of claim 27, wherein the list of places is an ordered list of places that indicates an order in which the given customer has habitually visited the list of places.

29. The method of claim 27, wherein the list of places is a non-ordered list of places that does not indicate an order in which the given customer has habitually visited the list of places.

30. The method of claim 27, further comprising:
classifying one or more of the listed places within the place movement pattern profile.

31. The method of claim 30, wherein the classifying includes identifying at least one class of products and/or services associated with the one or more places and adding the identified class of products and/or services to the place movement pattern profile.

32. The method of claim 31, wherein the at least one class of products and/or services includes multiples classes of products.

33. The method of claim 31, wherein the at least one class of products and/or services includes groceries, electronics and/or medical.

34. The method of claim 27, wherein the generating includes:
identifying, based on the monitoring, a set of locations visited by the given customer that each correspond to a distinct geographical area at which a threshold number of users converge at or cluster; and
populating the list of places of the place movement pattern profile with places that correspond to the set of locations based on the determination.

35. A communications device configured to deliver advertisements, comprising:
means for determining, for a given customer, advertisement campaign rules for presentation of advertisements for at least one service of a given vendor to which the given customer subscribes based upon a place movement pattern profile of the given customer, wherein the place movement pattern profile includes a list of places that the given customer has habitually visited within a threshold period of time of each other, the list of places including at least one competitor of the given vendor;
means for detecting that the given customer is engaged in a given visit to the list of places in a manner consistent with the place movement pattern profile; and
means for delivering advertisements to the given customer on behalf of the given vendor based upon the advertisement campaign rules in response to the detection.

36. The communications device of claim 35, wherein the communications device corresponds to (i) a server or (ii) a mobile device associated with the given customer.

37. A communications device configured to deliver advertisements, comprising:
means for monitoring movement of a given customer that subscribes to at least one service of a given vendor;
means for determining, based on the monitoring, a list of places that are habitually visited by the given customer within a threshold period of time of each other, the list of places including at least one competitor of the given vendor; and
means for generating a place movement pattern profile based on the list of places.

38. The communications device of claim 37, wherein the communications device corresponds to (i) a server or (ii) a mobile device associated with the given customer.

39. A communications device configured to deliver advertisements, comprising:
logic configured to determine, for a given customer, advertisement campaign rules for presentation of advertisements for at least one service of a given vendor to which the given customer subscribes based upon a place movement pattern profile of the given customer, wherein the place movement pattern profile includes a list of places that the given customer has habitually visited within a threshold period of time of each other, the list of places including at least one competitor of the given vendor;
logic configured to detect that the given customer is engaged in a given visit to the list of places in a manner consistent with the place movement pattern profile; and
logic configured to deliver advertisements to the given customer on behalf of the given vendor based upon the advertisement campaign rules in response to the detection.

40. The communications device of claim 39, wherein the communications device corresponds to (i) a server or (ii) a mobile device associated with the given customer.

41. A communications device configured to deliver advertisements, comprising:
logic configured to monitor movement of a given customer that subscribes to at least one service of a given vendor;
logic configured to determine, based on the monitoring, a list of places that are habitually visited by the given customer within a threshold period of time of each other, the list of places including at least one competitor of the given vendor; and
logic configured to generate a place movement pattern profile based on the list of places.

42. The communications device of claim 41, wherein the communications device corresponds to (i) a server or (ii) a mobile device associated with the given customer.

43. A non-transitory computer-readable medium containing instructions stored thereon, which, when executed by a communications device configured to deliver advertisements, causes the communications device to perform operations, the instructions comprising:
at least one instruction for causing the communications device to determine, for a given customer, advertisement campaign rules for presentation of advertisements for at least one service of a given vendor to which the given customer subscribes based upon a place movement pattern profile of the given customer, wherein the place movement pattern profile includes a list of places that the given customer has habitually visited within a threshold period of time of each other, the list of places including at least one competitor of the given vendor;
at least one instruction for causing the communications device to detect that the given customer is engaged in a given visit to the list of places in a manner consistent with the place movement pattern profile; and
at least one instruction for causing the communications device to deliver advertisements to the given customer on behalf of the given vendor based upon the advertisement campaign rules in response to the detection.

44. The non-transitory computer-readable medium of claim 43, wherein the communications device corresponds to (i) a server or (ii) a mobile device associated with the given customer.

45. A non-transitory computer-readable medium containing instructions stored thereon, which, when executed by a communications device configured to deliver advertisements, causes the communications device to perform operations, the instructions comprising:
at least one instruction for causing the communications device to monitor movement of a given customer that subscribes to at least one service of a given vendor;
at least one instruction for causing the communications device to determine, based on the monitoring, a list of places that are habitually visited by the given customer within a threshold period of time of each other, the list of places including at least one competitor of the given vendor; and
at least one instruction for causing the communications device to generate a place movement pattern profile based on the list of places.

46. The non-transitory computer-readable medium of claim 45, wherein the communications device corresponds to (i) a server or (ii) a mobile device associated with the given customer.
